(19) United States
(12) Patent Application Publication
(10) Pub. No.: US 2015/0019173 A1
(43) Pub. Date: Jan. 15, 2015

(54) MULTIOBJECTIVE OPTIMIZATION THROUGH USER INTERACTIVE NAVIGATION IN A DESIGN SPACE

(71) Applicant: International Business Machines Corporation, Armonk, NY (US)

(72) Inventors: David Amid, Kiryat Ata (IL); Ateret Anaby-Tavor, Givat Ada (IL); David Boaz, Bahan (IL); Michael Masin, Haifa (IL); Shahar Chen, Omer (IL); Ofer Shir, Jerusalem (IL)

(21) Appl. No.: 13/937,231

(22) Filed: Jul. 9, 2013

(51) Int. Cl. G06F 17/50

(52) U.S. Cl. CPC G06F 17/50
USPC 703/1

(57) ABSTRACT

A computerized method of providing a multiobjective optimal design through user interactive navigation, comprising:
1) Designating a user reference design which defines multiple objectives in a design space.
2) Exploring the design space to identify a multiobjective optimal design, evolved from the reference design, through multiple navigation iterations. During each iteration the user is interacted to reach an intermediate candidate design which is closer to a Pareto frontier. Each iteration comprising:
   (a) Identifying and presenting the user, optimal designs which are closer to the Pareto frontier and are within a pre-defined evolution distance from an intermediate design of previous iteration, improving one or more of the objectives.
   (b) Selecting a preferred design from those candidate designs, according to user instructions, the preferred design is used as the starting point for the next iteration.
   (c) Outputting the preferred design selected at the final iteration and considered as the multiobjective optimal design.

### BACKGROUND

The present invention, in some embodiments thereof, relates to multiobjective optimization, and, more specifically, but not exclusively, to a user interactive multiobjective optimization and solution identification.

As systems, products, processes and/or solutions are becoming more and more complex they are characterized with multiple objectives that need to be addressed and met. These objectives may conflict each other and finding an optimal solution presents a major challenge especially as human users may find it hard to comprehend and/or cope with the entire scope of the problem. Multiobjective optimization is therefore highly beneficial for finding an optimal solution in a multiobjective design space. The optimal solution may be considered as the most preferred trade-off between conflicting objectives.

Using automated, machine based, analytical tools for resolving and/or optimizing the multiobjective problems may be very advantageous, however the results provided by the automated tools may not be easily accepted by human users who make the decisions on the desired solution. The users may experience, for example, fixation, predetermined expectations and/or personal favorable solution paths which may prevent them from accepting the machine optimization driven results, especially in events where the automated results differ dramatically from the original design of the user and/or from the design perceived by the user.

### SUMMARY

According to some embodiments of the present invention, there are provided methods for designating a multiobjective optimal design through user interactive navigation. A user designates a reference design in a design space. The reference design defines a plurality of objectives. The design space is explored to identify a multiobjective optimal design, evolved from the reference design, through a plurality of navigation iterations. Each navigation iteration is performed interactively with the user to reach an intermediate optimal design which is closer to a Pareto frontier than a preceding intermediate optimal design. Each navigation iteration comprises:
Identifying and presenting to the user, a plurality of optimal designs which are closer to the Pareto frontier. The plurality of optimal designs is within a pre-defined evolution distance from the intermediate optimal design selected at the previous navigation iteration. Each one of the plurality of optimal designs improves at least one of the plurality of objectives.
Selecting a preferred design from the plurality of optimal designs according to instructions provided by the user. The preferred design is used as a start point for the next navigation iteration.
   After navigation is complete the preferred design which is selected at the final navigation iteration is outputted as the multiobjective optimal design.

Optionally, the plurality of optimal designs are retrieved from an archive created offline prior to the interactive iterations.

Optionally, the plurality of optimal designs are calculated in real time.

Optionally, the plurality of optimal designs are located in close proximity to the Pareto frontier.

Optionally, the plurality of optimal designs are located on at least one path to the Pareto frontier and are within the pre-defined evolution distance from the intermediate optimal design.

Optionally, the navigation is performed automatically with no user intervention.

Optionally, the navigation completes when no further optimal designs are identified.

Optionally, the navigation completes on instruction from said user.

Optionally, the intermediate optimal design consists of several temporary designs which gradually evolve to provide a feasible design that is closer to the Pareto frontier.

Optionally, each one of the plurality of optimal designs is Pareto dominating the intermediate optimal design of the current navigation iteration.

Optionally, the evolution distance is set by said user.

Optionally, the evolution distance is set automatically according to analysis made over the design space to identify the plurality of optimal designs.

Optionally, the plurality of optimal designs are identified on at least one shortest path to the Pareto frontier.

Optionally, the at least one shortest path is defined by having lowest accumulated evolution distance to the Pareto frontier.

Optionally, the at least one shortest path is defined by having fewest navigation iterations to reach the Pareto frontier.

Optionally, the plurality of optimal designs are identified according to at least one selection criterion for advancing toward the Pareto frontier.

Optionally, the plurality of optimal designs are filtered to remove candidate designs which are outside of a region of interest of the user.

According to some embodiments of the present invention, there are provided systems for providing a multiobjective optimal design through user interactive optimization. The system includes a processor, a user interface module which interacts with a user to designate a reference design in a design space and an optimization module. The reference design defines a plurality of objectives and performs as a starting point for a multiobjective navigation process. The optimization module calculates the Pareto frontier of a given model and identifies a multiobjective optimal design, evolved from the reference design, which is closest to a Pareto frontier by exploring the design space through a plurality of navigation iterations starting from the reference design. Each one of the navigation iteration is performed interactively with the user using the user interface module to select one of a plurality of intermediate candidate designs which are within a pre-defined evolution distance from the design selected in the previous navigation iteration. The intermediate candidate design improves at least one of the plurality of objectives. The intermediate optimal design of the final navigation iteration is considered as the multiobjective optimal design.

Optionally, the system is a distributed system which includes at least two processing units communicating with each other through at least one of a plurality of networks.

According to some embodiments of the present invention, there are provided a computer program product for providing a multiobjective optimal design through user interactive optimization. The computer program product includes a computer readable storage medium. The computer program product includes first program instructions to designate by a user, a reference design in a design space. The reference design defines a plurality of objectives and performs as a starting point for an optimization process. The computer program product includes second program instructions to perform multiobjective optimization, evolved from the reference design, design in order to provide a multiobjective optimal design which is closest to a Pareto frontier by exploring the design space through a plurality of navigation iterations starting from the reference design. Each one of the plurality of navigation iterations is performed interactively with the user to reach an intermediate optimal design within a pre-defined evolution distance from the previous navigation iteration design. The intermediate optimal design improves at least one of the plurality of objectives. The computer program product includes third program instructions to interact with the user in order to present optimization results of the plurality of navigation iterations to the user. The computer program product includes fourth program instructions to interact with the user in order to receive from the user instructions to control the optimization process. The first, second, third and fourth program instructions are stored on the computer readable storage medium.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a flowchart of an exemplary user interactive online multiobjective optimization process, according to some embodiments of the present invention;

FIG. 1B is a flowchart of an exemplary user interactive offline multiobjective optimization process, according to some embodiments of the present invention;

FIG. 2 is a schematic illustration of an exemplary system for interactive multiobjective optimization, according to some embodiments of the present invention; and

FIG. 3 is a schematic illustration of an exemplary optimization progress using batch algorithm in a two-dimensional (bi-objective) multiobjective optimization problem, according to some embodiments of the present invention.

### DETAILED DESCRIPTION

The present invention, in some embodiments thereof, relates to multiobjective optimization of a reference design, and, more specifically, but not exclusively, to a user interactive multiobjective optimization a reference design, by seeking a Pareto efficient design and solution identification.

According to some embodiments of the present invention, there are provided systems and methods for improving parameters of a user designated multiobjective design through a user interactive process. In this process a reference design is designated by the user and is gradually improved through a plurality of separate evolution steps towards an optimal multiobjective solution and/or design. This iterative gradual evolution towards an optimal multiobjective design is based on a plurality of user interactions during which the user controls the evolution. The involvement of the user in the gradual evolution of the design toward the optimal multiobjective design contributes to the comprehension and/or confidence the user holds in the suggested optimization design. The interactive nature of the optimization process may also allow the user to identify deficiencies, for example, the scope of the proposed design and/or the characterization of the design objectives.

The optimization is an iterative process based on multiple navigation iterations through the design space starting from the reference design of the user and moving through one or more intermediate designs towards a Pareto frontier identified in the design space.

The optimization process supports two operation modes—offline mode and online mode. In the offline mode the Pareto Frontier is computed offline and intermediate designs are created and stored in an archive. In the online mode the intermediate designs are created in real time based on a local Pareto frontier which is also computed in real time. In both modes, each navigation iteration presents an evolution step which brings the design closer to the Pareto frontier using, for example, Pareto efficiency for identifying optimal multiobjective designs. The user may set a pre-defined value for a range and/or a distance of the evolution step made from the current reference design to the intermediate optimal design so as to define how large is the evolution step.

At each navigation iteration a plurality of candidate intermediate optimal designs and/or optional parameter changes are presented to the user. The candidate intermediate optimal designs may be either retrieved from the archive (offline mode) or computed online. The user may select one of the presented intermediate optimal intermediate candidate designs so as to guide the navigation process through a desired path. The process may proceed until the Pareto frontier is reached, i.e. no further better design is identified, the Pareto frontier is approximately reached and/or the navigation/optimization process is stopped by the user.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

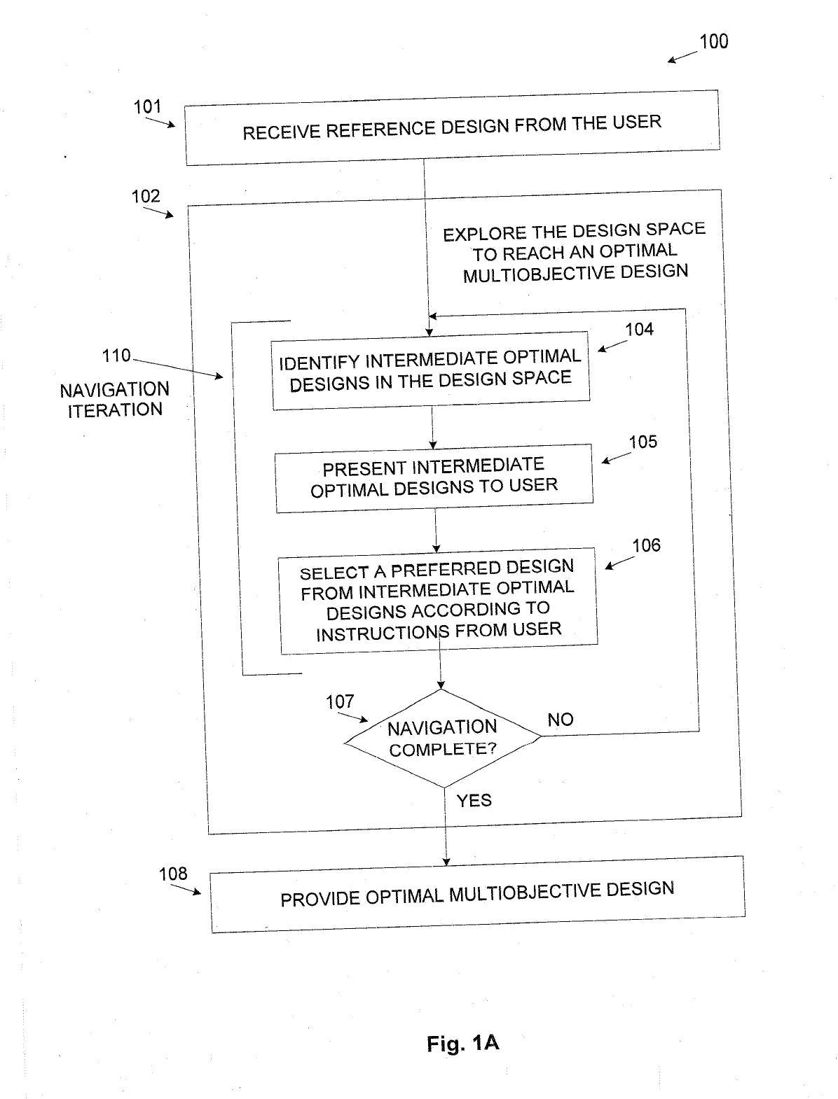

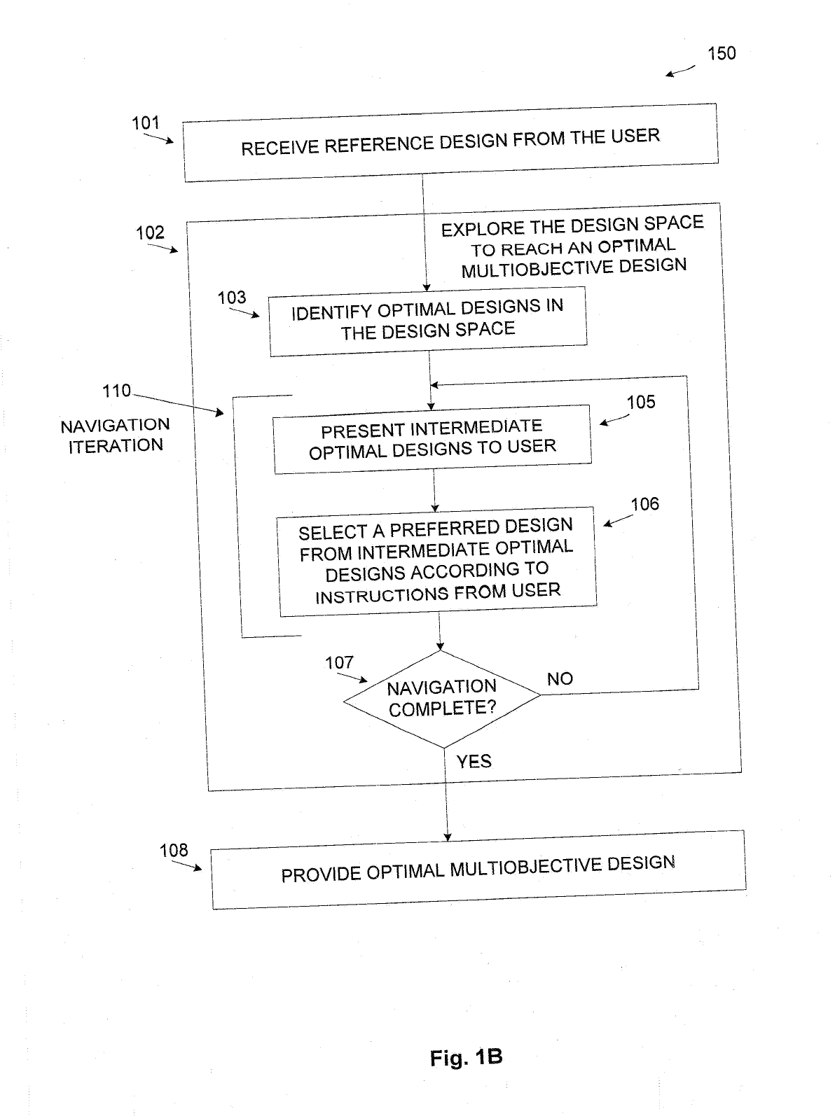

Reference is now made to FIG. 1A which is a flowchart of an exemplary user interactive online multiobjective optimization process, according to some embodiments of the present invention.

As shown at 101, an exemplary interactive multiobjective navigation process 100 utilizing the online optimization mode starts with a user designating a reference design. It is assumed, as it is typically is, that the reference design is suboptimal. The reference design defines multiple objectives which need to be addressed and fulfilled. The multiobjective nature of the design suggests that there is a spectrum of optimal multiobjective solutions in the design space due to inherent conflicts between the objectives.

As shown at 102, exploring the design space for the multiobjective optimal design is performed through a plurality of navigation iterations 110. The first navigation iteration 110 uses the user reference design as a starting point design. The starting point design for each of the following navigation iteration 110 is the intermediate optimal design identified in the previous navigation iteration 110. The range and/or evolution distance of the optimal design identified in each evolution step (navigation iteration 110) from the starting point design may be set by the user so as to define how large is the evolution in the identified intermediate optimal designs. The optimization process 100 identifies one or more optimal designs in the design space, for example, by identifying a Pareto frontier for the design space. One or more optimal design may reside on the Pareto frontier or in proximity to it.

As shown at 104, during each one of the plurality of navigation iterations 110, a plurality of intermediate optimal designs are identified in real time in the design space. The plurality of intermediate optimal designs is located within the pre-defined evolution distance from the starting point design. The identified intermediate optimal designs may reside, for example, on one of the paths leading to the Pareto frontier and/or on a local Pareto frontier which is local with respect to the starting point device. The optimization process may further employ, for example, Pareto efficiency approach by computing the Pareto frontier in real time and creating on-the-fly, by employing, for example, Pareto efficiency analysis, one or more intermediate optimal designs which Pareto dominate the starting point design of the current navigation iteration 110.

As shown at 105, the plurality of intermediate optimal designs is presented to the user through, for example, visual presentation and/or mathematical presentation. The presentation of the intermediate optimal designs which are multiobjective may be reduced in their dimensions, for example, two dimensions (2D) and/or three dimensions (3D) so as to allow the user a simpler view allowing the user to comprehend the presented intermediate optimal designs. Presentation may also be done through ranking the intermediate optimal designs relatively to the starting point design. Each of the plurality of objectives may be assigned with a score indicating its variation with respect to the starting point design. When the optimization employs, for example, Pareto efficiency analysis, Pareto ranking may be assigned to each one of the plurality of intermediate optimal designs.

As shown at 106, the user selects one of the presented intermediate optimal designs. This allows the user to control the evolution path of the design towards the Pareto frontier.

While the user is presented with intermediate optimal designs and is able to control the path of progress, the user may more easily accept and adapt to the design evolution proposed by the automated optimization process. Further to that, through the interactive process of navigation, the user may identify flaws and/or deficiencies in the design scope, design objectives and/or design space. As a consequence, the user may better define, for example, the design objectives, the design scope and/or the design space according to the observations the user makes during the interactive optimization process.

As shown at 107, which is a decision point for stopping the navigation process, a navigation end condition is checked for validity. The end condition may be, for example, no better designs exist with respect to the current design point, reaching a pre-defined optimization end condition and/or a user intervention to end the navigation. In case the navigation end condition is valid (YES) the navigation process branches to 108. In case the condition is not fulfilled (NO), the navigation process will jump to 104 to initiate another navigation iteration 110.

As shown at 108, the multiobjective optimal design is provided to the user. The multiobjective optimal design is the optimal design identified during the final navigation iteration 110 of the design process 100.

Reference is now made to FIG. 1B which is a flowchart of an exemplary user interactive offline multiobjective optimization process, according to some embodiments of the present invention.

As shown at 101, an exemplary interactive multiobjective navigation process 150 utilizing the offline optimization mode starts the same as the process 100, with a user designating a reference design.

As shown at 102, exploring the design space for the multiobjective optimal design is performed through a plurality of navigation iterations 110 as is done in the process 100.

As shown at 103, the optimization process 150 identifies one or more optimal designs in the design space, for example, by identifying the Pareto frontier for the design space. One or more optimal design may reside on the Pareto frontier or in proximity to it. The plurality of intermediate optimal designs may be created offline, for example, by computing the Pareto frontier and maintaining records of suboptimal and/or intermediate optimal designs solutions. The recorded intermediate optimal designs may be stored in an archive.

During each one of the plurality of navigation iterations 110, a subset of the plurality of the stored intermediate optimal designs are retrieved from the archive, evaluated and presented to the user.

As shown at 105, the subset of intermediate optimal designs is presented to the user. The subset includes intermediate optimal designs based on their location with respect to the starting point of the intermediate optimal design of the previous navigation iteration 110, for example intermediate optimal designs which are located within the pre-defined evolution distance from the starting point design. The presented intermediate optimal designs may reside on one of the paths leading to the Pareto frontier. The plurality of intermediate optimal designs may be presented to the user the same as is done in the process 100.

Step 106 through 108 are followed the same as is done for the process 100 with the exception that at 107 in case another navigation iteration 110 is to be initiated, the process 150 jumps to 105.

Optionally, during the iterative optimization process 100 and/or 150, candidate designs may be filtered out from the presentation to the user. Such candidate designs may be filtered as they reside on pathways to the Pareto frontier which are out of a region of interest of the user. Entire pathways which are of no interest to the user may be filtered out and excluded from the presentation to the user.

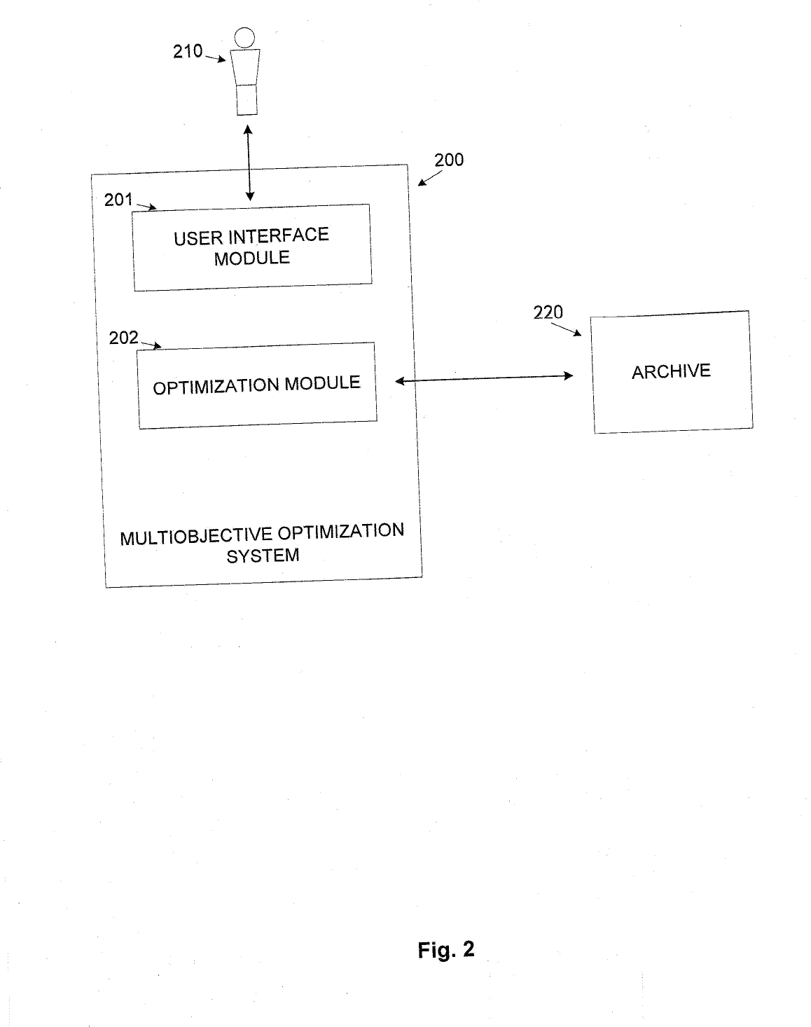

Reference is now made to FIG. 2 which is a schematic illustration of an exemplary system for interactive multiobjective optimization, according to some embodiments of the present invention. An optimization system 200 includes a user interface module 201 and an optimization module 202. The optimization 200 is executed on one or more of a plurality of processing units, for example, desktop computer, laptop computer, server and/or cluster of processing nodes, which are capable of executing program instructions. The optimization module 202 performing the optimization interacts with a user 210 through the user interface module 201 which may provide input and/or output, for example, visual interface, textual interface and/or audio interface. Input of the user interface module 201 may include, for example, keyboard, mouse, touch screen, audio interface and/or other human-machine interfaces. Output of the user interface module 201 may include, for example, display, printer, audio interface and/or other human-machine interfaces. The user 210 provides the optimization system 200 with a reference design using the user interface module 201. The reference design is relayed to the optimization module 202 which performs the optimization process, for example, using the process 100. Interaction with the users 210 may further include, for example, presentation of the optimization progress, presentation of results, reception of instructions for guiding the optimization process and/or instructions for completing the optimization process.

Optionally, the optimization system 200 has access to an archive 220 which stores a plurality of designs created during previous one or more optimization processes. One or more of the plurality of designs may be used as candidate designs during the optimization process.

Optionally, the optimization module 202 is executed remotely from the user 210. The user 210 interacts with the optimization system through the user interface module 210 which communicates with the optimization module over one or more networks, for example, local area network (LAN), wireless local area network (WLAN), internet and/or cellular. The users interface module may be utilized through one or more of a plurality of client terminals, for example, workstation, desktop computer, laptop computer, tablet and/or Smartphone.

According to some embodiments of the present invention, a computer program is provided for executing the interactive multiobjective optimization process such as, for example, the optimization process 100. The computer program may execute on one or more of a plurality of processing units, for example, desktop computer, laptop computer, server and/or cluster of processing nodes, which are capable of executing program instructions.

According to some embodiments of the present invention, the multiobjective optimization utilizes Pareto efficiency analysis. An exemplary optimization algorithm is provided which describes a Pareto efficiency directed optimization process where a solution (design) is considered optimal if it is not Pareto dominated by any other solution. The exemplary optimization algorithm presented herein is one possible implementation and is not intended to limit the scope of the invention, other implementation may be applied.

A multiobjective optimization problem typically comprises several objective functions which, without loss of generality, need to be minimized Typically, there exists a spectrum of optimal solutions for the problem due to inherent conflicts between the plurality of objectives. In the high-dimensional objective space a preference relation, which is of a partial order, is defined over the objective vectors of two candidate solutions. The vector of objectives is denoted a described in Equation 1 below:

\vec{f}(\vec{x})=(f₁(\vec{x})·f₂(\vec{x}) . . . fₘ(\vec{x}))^{T} Equation 1:

m denotes the number of objective functions.
Engineering problems typically aim to minimize the value of the objective, for example, lower costs, lower architectural elements count and/or lower time to market. Therefore a solution (1) strictly Pareto dominates solution (2) if and only if the condition described in Equation 2 is satisfied.

∀iε{1 . . . m}:fᵢ⁽¹⁾≦f₂⁽¹⁾ [symbol] □∃iε{1 . . . m}:fᵢ⁽¹⁾<f₂⁽¹⁾ Equation 2:

A set of nomenclature which is used throughout the navigation algorithm is provided in Table 1 below.

TABLE 1

| Term | Description | Notation |
|---|---|---|
| Model | multiobjective optimization model | M |
| Pareto | set of non-dominated points in the | F |
| Frontier | m-dimensional objective space | |
| Archive | the entire set of candidate solutions | A |
| | obtained during optimization | |
| Solution | a feasible solution to the given multi- | ψ |
| | objective problem | |
| reference | a solution provided by the user to become | ψ [symbol] |
| | the initial/reference point | |
| path | a sequence of candidate solutions from the | p, P[:] |
| | reference to the Frontier | |

Graph Related

| | | |
|---|---|---|
| directed | a graph with vertices V and directed edges | G = {V, E} |
| acyclic | E possessing no cycles | |
| graph | | |
| distance | δ(s, [symbol] ) the total distance from a source | d[u] |
| from | vertex s to u: | |
| source | | |
| predecessor | a vertex that appears prior to v in a | π[ν] |
| to v | prescribed path | |
| adjacency | the set of vertices connected to u | Adjacancy[u] |
| to u | | |
| heap | a tree-based data structure satisfying the | Q |
| | heap property | |
| extractMin( ) | a function removing from a heap the node | |
| | with the minimal key | |

[symbol]

indicates data missing or illegible when filed

Optionally, the navigation algorithm identifies optimal solutions from the archive, which holds a plurality of feasible solutions, either optimal or suboptimal, computed during previous optimization processes. This operation mode is referred to as batch algorithm and is performed through an exemplary procedure batchNavigateMO( ) which is described in pseudo code excerpt 1. The batchNavigateMO( ) procedure is the high level module which allows the user to designate the reference design and invokes the search mode desired by the user.

Pseudo Code Excerpt 1:

```
                      ψ  ^{A}
batchNavigateMO (reference , archive , limit
δ₁max, int mode,neighbors N₁max)
1. IF [symbol]    isFeasible(ψ) THEN
2.  PRINT (ListViolatedConstraints(ψ))
3.  RETURN NULL
4. END IF
5. F [symbol]    calculatedParetoFrontier(A)
      ψ ε F [symbol]    □ isParetoNonDominated(ψ,□)
6.  IF
7.  PRINT (The given reference is Pareto optimal)
8.  RETURN ψ
9.  END IF
10. Δ ← setDistanceMetric(□)
11. SWITCH (mode)
12. CASE CLOSEST:
13. idx ← findClosestSolutionOnFrontier(ψ,F,A,Δ)
14. RETURN F[idx]
15. CASE SHORTEST:
16. {p,idx} ← findShortestPathToFrontier(ψ,F,A,Δ,δₘₐₓ)
17. PRINT (p)
18. RETURN F[idx]
19. DEFAULT:
20. RETURN roverToFrontier(ψ,A,Δ,δₘₐₓ,Nₘₐₓ)
21. END SWITCH [symbol]
indicates data missing or illegible when filed
```

The batchNavigateMO( ) receives a reference solution ψ, an archive A, a maximal distance δ_{MAX}, an operation mode selection flag mode and maximal number of candidate neighbors N_{MAX}.

Initially, the batchNavigateMO( ) procedure may check to see if the reference solution is feasible with respect to the possible plurality of constraints it presents (as seen at line 1). In case the solution is infeasible, the procedure reports a message of constraints violation to the user (as seen at line 2) and branches (as seen at line 3). A Pareto frontier is then calculated (as seen at line 5) and the reference solution is checked to identify if there are optimal solution on the Pareto frontier that Pareto dominate it (as seen at line 6). In case there are no such Pareto dominating solutions, the algorithm considers the reference solution as the optimal solution, reports the user (as seen at line 7) and branches, returning the reference solution (as seen at line 8). In case the reference solution does not lie on the Frontier, i.e. Pareto dominating solutions are identified, the procedure continues and initializes the evolution distance metric Δ (as seen at line 10).

Optionally, the user selects to obtain the optimal multiobjective solution by finding a solution point that resides on the Pareto frontier and is the closest solution
ψ
   point to the current solution point (reference solution) in the design space. This option may be utilized through the procedure findClosestSolutionOnFrontier(□) (as seen at line 13). The findClosestSolutionOnFrontier( ) is not an iterative process as the one or more optimal designs presented to the user are already located on the Pareto frontier and/or approximately on the Pareto frontier. The user may select the preferred design from the one or more presented optimal designs.

Optionally, the user selects to obtain the optimal multiobjective solution by identifying the shortest path to the Pareto frontier from the current solution point (reference solution ψ) in the design space. This option may be utilized through the procedure findShortestPathToFrontier(□) (as seen at line 16). The findShortestPathToFrontier( ) identifies one or more pathways from the reference design to the Pareto frontier. The findShortestPathToFrontier( ) procedure is described hereinafter.

Optionally, the user selects to obtain the optimal multiobjective solution by interactively guiding the algorithm on a desired path from the current solution point (reference solution ψ). This option may be utilized through the procedure roverToFrontier( ) (as seen at line 20). The roverToFrontier( ) procedure is an iterative process interacting with the user to select the evolution path for the reference design towards the Pareto frontier. The roverToFrontier( ) procedure is described hereinafter.

The shortest path from the current solution point to the optimal multiobjective solution residing on the Pareto frontier may be defined as the shortest sequence of navigation iterations 110, i.e. minimal number of transitions through intermediate solutions to the Pareto frontier. Alternatively, the shortest path to the Pareto frontier may be defined as the smallest accumulated evolution distance to the Pareto frontier where the evolution distance (in the design space) between each pair of consecutive intermediate solutions is bounded by δ_{MAX}. Calculation of the shortest path may be utilized through the findShortestPathToFrontier( ) procedure which is described in pseudo code excerpt 2 below.

Pseudo Code Excerpt 2:

findShortestPathToFrontier (reference ψ [symbol] ,Frontier F, archive ^{A} ,
metric ^{Δ}, limit δ₁MAX)
1. G ← constructParetoGraph(A,Δ,δₘₐₓ)
2. (D,P) ← G.runDijkstra(ψ [symbol] ,F)
3. idx ← argmin [symbol] (D [symbol] )
4. RETURN {P[idx],idx} [symbol]
indicates data missing or illegible when filed

The findShortestPathToFrontier( ) procedure receives a reference solution ψ [symbol] , a Pareto frontier F, an archive A, a distance metric Δ and a maximal distance δ_{MAX}.

The findShortestPathToFrontier( ) procedure creates a Pareto graph which maps the solution available from the archive into a graph (as seen at line 1). Pathways are calculated from the current reference solution to the Pareto frontier (as seen at line 2) and the shortest pathway is selected (as seen at line 3). The shortest path is then returned which may be the path which holds the lowest accumulated evolution distance to the Pareto frontier and/or the path that requires the fewest navigation iterations 110.

Optionally, the user selects to interact with the navigation algorithm through the roverToFrontier( ) procedure which is an iterative process described in pseudo code excerpt 3 below. During each of its navigation iterations, such as the navigation iterations 110, the roverToFrontier( ) procedure interactively returns a set of dominating solutions within the evolution distance (range) of the reference solution, where the evolution distance is defined by the limit δ_{MAX}. The set of dominating solutions resides on pathways to the Pareto Frontier. The user may select one of the returned dominating solutions so as to set guide the algorithm in the desired path.

Pseudo Code Excerpt 3:

roverToFrontier (reference ψ [symbol] , Frontier F, archive ^{A}, metric ^{Δ} , limit
δ₁MAX,neighbors N₁MAX)
1. G ← constructParetoGraph(A,Δ,δₘₐₓ)
2. ← 0
3. ← ø
4. REPEAT
5. (D,P) ← G.runDijkstra(ψ [symbol] , [symbol] )
6. I ← sort D, ( [symbol] [symbol] ascen [symbol] [symbol] )
7. N₁g (ψ [symbol] t) ← (v┤ | v ε P[l(1: N₁max)] [symbol] [symbol] ψ₁t == π(v)}
8. ψₜ₊₁ ← getDMSelection( [symbol] N [symbol] (ψ [symbol] ₜ))
9. p[t] ← (ψₜ → ψₜ₊₁)
10. t ← t + 1
11. UNTIL terminatedByDM(□)
12. PRINT (ψ)
13. RETURN ψₜ [symbol]
indicates data missing or illegible when filed

The roverToFrontier( ) receives a reference solution ψ [symbol] , a Pareto frontier F, an archive A, a distance metric Δ, a maximal distance δ_{MAX} and maximal number of candidate neighbors N_{MAX}.

The roverToFrontier( ) procedure is repeated for the plurality of navigation iterations 110 (as seen at line 4) until the navigation is completed and the optimal multiobjective solution is reached. The navigation process may continue until it reaches a completion criterion, for example, the optimal multiobjective solution of the current navigation iteration 110 resides on the Pareto frontier, or the user terminates the optimization process (as seen at line 11). One or more pathways from the current solution (of the current navigation iteration 110) to the Pareto frontier are attained (as seen at line 5). The attained pathways may also include their respective evolution distances from the current solution.

Optionally, the user set criteria for selecting a pathway to the Pareto frontier out of the attained pathways. The default selection criterion amongst the attained pathways may be, for example, minimizing the evolution distance between the current solution point to points on the Pareto frontier and selecting the first N_{max□} elements (as seen at line 6). However, alternative criteria may be instantiated, for example, filtering pathways, minimizing navigation iterations 110, maximizing improvements in two or more objectives and/or maximizing solution diversity. Filtering pathways may be performed on pathways towards the Pareto frontier whose first transition is to an intermediate solution which is Pareto dominated by the current solution with respect to Adjacancy( ). Maximizing improvements in two or more objectives may be utilized through a global utility function assessing the largest descent in two or more objectives and/or all objectives. Maximizing solution diversity may be selected in which the target optimal solution point on the Pareto frontier provides the maximum diversity in the design. One or more selection criterions may be combined to follow each other as primary and secondary criteria, for example, among the closest solution points to the Pareto frontier (primary criterion) select the solution points which provide the highest design diversity (secondary criterion).

Optionally, two or more selection criteria are used in scenarios in which the neighborhood of the reference solution point (or intermediate solution point) is crowded with many feasible solutions. For example, a primary criterion may be selecting the solutions that are Pareto dominating the current solution, and amongst the selected solutions, a secondary criterion may be applied for selecting the solutions that are closer (in proximity) to the current solution point (in order to maintain small evolution steps).

Optionally, the maximal evolution distance δ_{MAX} is adjusted to support scenarios in which no pathways from the current solution point to the Pareto frontier are obtained using, for example, findShortestPathToFrontier( ). In such a case the maximal distance may be increased in order to allow the navigation procedure to identify a pathway to the Pareto frontier. Adjustments to the maximal evolution distance may be done, for example, by the user, heuristically by the algorithm and/or through a hybrid approach combining heuristic information and user control. Adjustments to the maximal evolution distance may be done, for example, for the operation of the findShortestPathToFrontier( ) procedure and/or the roverToFrontier( ) procedure.

Optionally, the user has a preferred target region (region of interest) on the Pareto frontier which may be identified during the early stages of the interactive navigation process. This information may be used to filter out and/or eliminate pathways from the current solution to the optimal solutions on the Pareto frontier which are outside the region of interest to the user.

During its execution, the batch algorithm may evaluate the multiobjective solutions which are maintained in the archive and create a weighted directed acyclic graph as described in pseudo code excerpt 4 below. The graph is utilized for finding pathways in the design space to the Pareto frontier.

Code Excerpt 4:

```
constructParetoGraph (archive ^{A} , metric ^{Δ} , limit δ₁max)
1.  V ← A
2.  E ← ø
3.  FOR t = 1 . . . |A|  DO
4.  FOR j =1 . . . |A|  DO
      IF dominates(A[ [symbol]  ],A[ [symbol]   ]) [symbol]  Δ(i,j) ≦ δ_{max□} THEN
5.
      E ← E ∪ [symbol] [symbol]     → i,w = Δ(i,j) [symbol]
6.
7.  END IF
8.  END FOR
9.  END FOR
10. RETURN (V,E) [symbol]
indicates data missing or illegible when filed
```

The constructParetoGraph( ) receives an archive A, a distance metric Δ and a maximal distance δ_{MAX}.

Calculation of shortest path from the current solution in the design space to the Pareto frontier may be done using a plurality of algorithms. Calculation of the shortest path is performed after formulating a multiobjective problem, solving it while maintaining an archive, and constructing its graph by accounting to distances amongst candidate solution points in the design space. The calculation may be done, but is not limited to, using Dijkstra algorithm which is described in pseudo code excerpt 5. The calculation algorithm may be used for calculating the shortest path to global optimal solutions residing on the Pareto frontier and/or to a local (intermediate) optimal solutions residing on the path to the Pareto frontier.

Pseudo Code Excerpt 5:

```
runDjkstra (source ψ , targets F)
1.  FOR EACH vertex v ε V[G]  DO
2.  d[v] ← ∞
3.  π[v] ← NULL
4.  G ← constructParetoGraph(A,Δ,δₘₐₓ)
5.  d[ψ] ← 0
6.  5 ← ø
7.  Q ← V[G]
8.  WHILE Q ≠ ø  DO
9.  u ← extractMin(Q)
        S ← S ∪ ( [symbol]  )
10.
11.  FOR EACH vertex v ε Adj [symbol] [symbol]    cency[u]  DO
12.  IF d(v)> d(u) + w(u,v) THEN
13.  d(v) ← d(u) + w(u,v)
14.  π[v] ← u
15.  END IF
16.  END FOR
17. END WHILE
18. FOR EACH solution on the Frontier F[ [symbol]  ],  t = 1 . . . |F|  DO|
19.  D[t] ← d(F[ [symbol]  ])
20.  IF D[ [symbol]  ] < ∞ THEN
21. [symbol]    ← π[F[ [symbol]   ]]
22.  WHILE [symbol]  ≠ ψ  DO
        P[i] ← P[i] ∪ ( [symbol]  )
23.
24. [symbol]    ← π[ [symbol]  ]
25.  END WHILE
26.  ELSE
27.  P[ [symbol]   ] ← NULL
28.  END IF
29. END FOR
30. RETURN (D,P) [symbol]
indicates data missing or illegible when filed
```

The runDjkstra( ) algorithm receives a source solution and all the optimal solutions residing on the Pareto frontier F.
The runDjkstra( ) algorithm returns paths P and their associated evolution distances D (as seen at line 30). The paths indicate feasible pathways from the source solution to solution points on the Pareto frontier while the evolution distances indicate the evolution distance from the source solution point to the solution points on the Pareto frontier for each of the identifies paths.

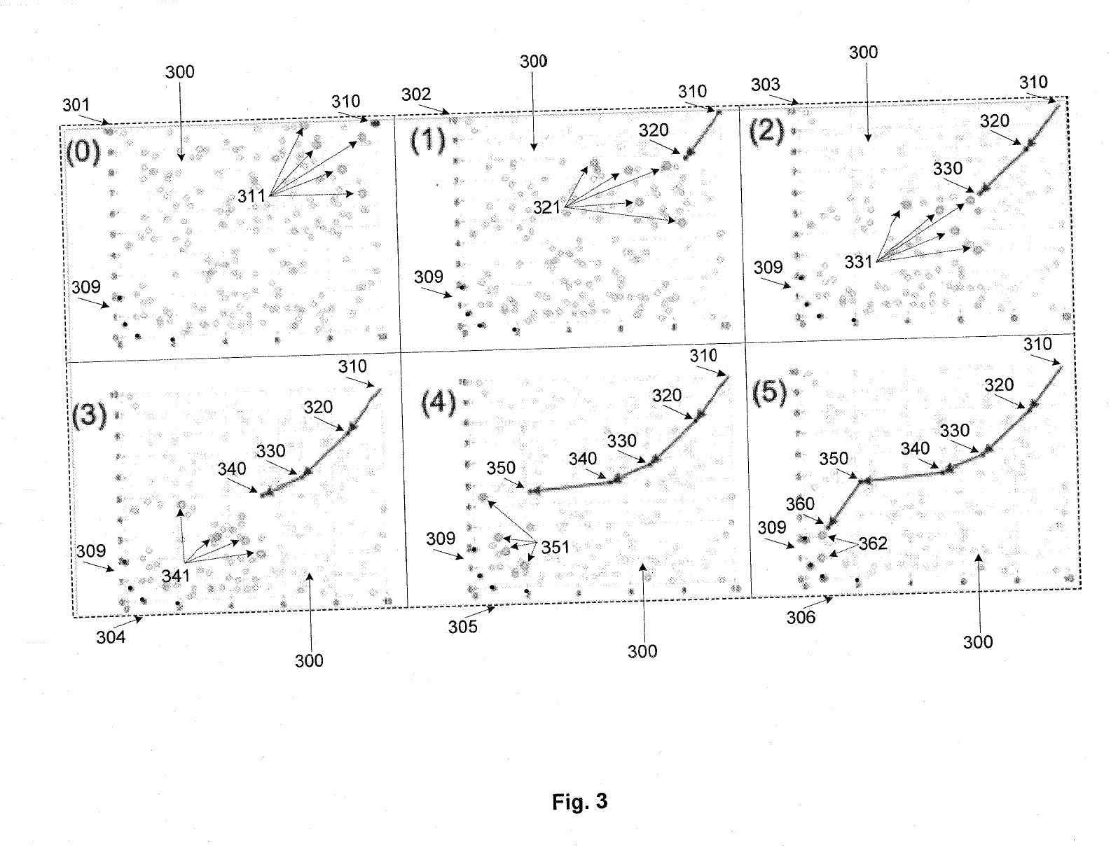

Reference is now made to FIG. 3 which is a schematic illustration of an exemplary optimization sequence using batch algorithm in a two-dimensional (bi-objective) multiobjective optimization problem, according to some embodiments of the present invention. A design space 300 is presented through the optimization advancement graphs 301 (0), 302 (1), 303 (2), 304 (3), 305 (4) and 306 (5), each representing the progress made by the navigation iteration 110. The design (solution) space 300 consists of a plurality of designs (solutions) which are represented through the dots spread around in the design space 330. A user reference design 310 is used as the starting point design for the navigation process. A Pareto frontier 309 is calculated and optimal designs, represented through bold dots, are identified on the Pareto frontier 309. During the first navigation iteration 110, presented in the graph 310 (0), a plurality of candidate designs 311 are identified in the design space 300. The candidate designs 311 are local optimal designs that Pareto dominate the reference design 310. The user selects one of the identified designs 320 which becomes the starting point design for the next iteration 110 as presented in the graph 302 (1). The same process is repeated in another navigation iteration 110 and a plurality of optimal designs 321 are identified in the design space 300. The user selects one of the identified designs 330 which becomes the starting point design for the next navigation iteration 110 as presented in the graph 303 (2). The navigation process continues interactively with the user through additional navigation iterations 110 as presented in the graphs 304 (3), 305 (4) and 306 (5). Each navigation iteration 110 brings the design closer to the Pareto frontier. The navigation progress is shown through the line going from the reference design point 310 through the intermediate optimal design points 320, 330, 340, 350 and 360. As can be seen, additional navigation may be done as there are optimal designs residing on the Pareto frontier 309 which Pareto dominate the design point 360. The navigation may proceed to one of the optimal designs residing on the Pareto frontier 309 or it may be halted by instruction from the user as he may be satisfied with the design point 360.

Optionally, the navigation algorithm optimizes the solution online by identifying optimal solutions in the design space in real time (on-the-fly) by interacting with the user without using available solutions from the archive. During each of the navigation iterations 110, the algorithm executes constrained Pareto optimization to identify intermediate optimal solutions in the design-proximity of the current solution point. The online algorithm onlineNavigateM0( ) procedure is described in pseudo code excerpt 6 below.

Pseudo Code Excerpt 6:

[symbol]

[symbol]

[symbol]

Δ ψ₀
) ,limit , metric onlineNavigateMO (model M, reference
1. t ← 0
2. p ← ø
3. REPEAT
4. R ← formMO(M,ψ,Δ,δₘₐₓ)
5. N [symbol] (ψₜ) ← solveLocal(R)
6. ψₜ₊₁ ← getDMSelection(N [symbol] (ψₜ))
7. p(t) ← (ψₜ → ψₜ₊₁)
8. t ← t + 1
9. UNTIL terminatedByDM(□)
10. PRINT (ψ)
11. RETURN ψₜ [symbol]
indicates data missing or illegible when filed

The onlineNavigateMO( ) procedure receives a multiobjective model M, a reference solution ψ [symbol] , a distance metric Δ, and a maximal distance δ_{MAX}.

The optimization process employed by the onlineNavigateMO( ) procedure is performed in a plurality of navigation iterations 110 (as seen at line 3). During each navigation iteration 110 a variant R is formulated (as seen at line 4) which is a local and/or constrained multiobjective optimization problem with respect to the current solution design point ψₜ. The variant R is then solved (as seen at line 5) to obtain the local Pareto frontier with regard to the current solution design point ψₜ of the current navigation iteration 110. The locality of the attained solutions in the decision space may be guaranteed by the constraints derived in the variant R. The user is asked to select a preferred solution (as seen at line 6) and that solution is then set to become the starting point for the next navigation iteration 110.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the term commerce information and price is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method of providing a multiobjective optimal design through user interactive navigation, comprising:
designating, using a computerized processor, by a user, a user reference design in a design space, said reference design defines a plurality of objectives;
exploring, using a computerized processor, said design space to identify a multiobjective optimal design, evolved from said reference design, through a plurality of navigation iterations, each said navigation iteration is performed interactively with said user to reach an intermediate optimal design which is closer to a Pareto frontier than a preceding intermediate optimal design, each said navigation iteration comprising:
identifying and presenting to said user, a plurality of optimal designs which are closer to said Pareto frontier, said plurality of optimal designs are within a pre-defined evolution distance from said intermediate optimal design selected at a previous navigation iteration, each one of said plurality of optimal designs improves at least one of said plurality of objectives, and
selecting a preferred design from said plurality of optimal designs according to instructions provided by said user, said preferred design is used as a start point for a next navigation iteration; and
outputting, after completing navigation, said preferred design which is selected at a final navigation iteration and is considered as said multiobjective optimal design.

2. The method of claim 1, wherein said plurality of optimal designs are retrieved from an archive created offline prior to said interactive iterations.

3. The method of claim 1, wherein said plurality of optimal designs are calculated in real time.

4. The method of claim 1, wherein said plurality of optimal designs are located in close proximity to said Pareto frontier.

5. The method of claim 1, wherein said plurality of optimal designs are located on at least one path to said Pareto frontier and are within said pre-defined evolution distance from said intermediate optimal design.

6. The method of claim 1, wherein said navigation is performed automatically with no user intervention.

7. The method of claim 1, wherein said navigation completes when no further optimal designs are identified.

8. The method of claim 1, wherein said navigation completes on instruction from said user.

9. The method of claim 1, wherein said intermediate optimal design consists of several temporary designs which gradually evolve to provide a feasible design that is closer to said Pareto frontier.

10. The method of claim 1, wherein each one of said plurality of optimal designs is Pareto dominating said intermediate optimal design of said current navigation iteration.

11. The method of claim 1, wherein said evolution distance is set by said user.

12. The method of claim 1, wherein said evolution distance is set automatically according to analysis made over said design space to identify said plurality of optimal designs.

13. The method of claim 1, wherein said plurality of optimal designs are identified on at least one shortest path to said Pareto frontier.

14. The method of claim 13, wherein said at least one shortest path is defined by having a lowest accumulated evolution distance to said Pareto frontier.

15. The method of claim 13, wherein said at least one shortest path is defined by having a fewest navigation iterations to reach said Pareto frontier.

16. The method of claim 13, wherein said plurality of optimal designs are identified according to at least one selection criterion for advancing toward said Pareto frontier.

17. The method of claim 1, wherein said plurality of optimal designs are filtered to remove candidate designs which are outside of a region of interest of said user.

18. A system for providing a multiobjective optimal design through user interactive optimization, comprising:
a processor;
a user interface module which interacts with a user to designate a reference design in a design space, said reference design defines a plurality of objectives and performs as a starting point for a multiobjective navigation process; and
an optimization module which calculates the Pareto frontier of a given model and identifies a multiobjective optimal design, evolved from said reference design, which is closest to a Pareto frontier by exploring said design space through a plurality of navigation iterations starting from said reference design, each said navigation iteration is performed interactively with said user using said user interface module to select one of a plurality of intermediate candidate designs which are within a pre-defined evolution distance from a design of said a previous navigation iteration, said intermediate candidate design improves at least one of said plurality of objectives,
wherein said intermediate optimal design of a final navigation iteration is considered as said multiobjective optimal design.

19. The system of claim 18, wherein said system is a distributed system which includes at least two processing units communicating with each other through at least one of a plurality of networks.

20. A computer program product for providing a multiobjective optimal design through user interactive optimization, comprising:
a computer readable storage medium;
first program instructions to designate by a user, a reference design in a design space, said reference design defines a plurality of objectives and performs as a starting point for an optimization process;
second program instructions to perform multiobjective optimization, evolved from said reference design, design in order to provide a multiobjective optimal design which is closest to a Pareto frontier by exploring said design space through a plurality of navigation iterations starting from said reference design, each said navigation iteration is performed interactively with said user to reach an intermediate optimal design within a pre-defined evolution distance from said a previous navigation iteration design, said intermediate optimal design improves at least one of said plurality of objectives;
third program instructions to interact with said user in order to present optimization results of said plurality of navigation iterations to said user; and
fourth program instructions to interact with said user in order to receive from said user instructions to control said optimization process;
wherein said first, second, third and fourth program instructions are stored on said computer readable storage medium.
